(19) United States
(12) Patent Application Publication
(10) Pub. No.: US 2019/0187678 A1
(43) Pub. Date: Jun. 20, 2019

(54) Piping Monitoring and Analysis System

(71) Applicant: Suncor Energy Inc., Calgary (CA)

(72) Inventors: Stephen MUINDA, Calgary (CA); Millar IVERSON, Calgary (CA); Greg GAUDET, Calgary (CA); Mohammad CHADY, Calgary (CA); Feng JU, Calgary (CA)

(21) Appl. No.: 16/219,393

(22) Filed: Dec. 13, 2018

(30) Foreign Application Priority Data
Dec. 20, 2017 (CA) 2989566

(51) Int. Cl. G05B 23/02; G05B 13/04; G05B 13/02; F17D 5/06; G01M 3/00; G01M 3/28

(52) U.S. Cl. CPC G05B 23/0283; G05B 13/048; G01M 3/2815; F17D 5/06; G01M 3/002; G05B 13/0265

(57) ABSTRACT

A system and method are provided for monitoring a piping network. The method includes obtaining data comprising temperature, displacement, and vibration measurements from a plurality of sensor assemblies. The sensor assemblies are selectively installed at a plurality of locations in the piping network, and the piping network is subjected to at least one multi-phase flow effect during its operation. The method also includes analyzing the data using at least one model to: predict pipe life, detect an operational or pipe damage event, and/or trigger preventative maintenance.

### CROSS-REFERENCE TO RELATED APPLICATION(S)

This application claims the benefit of priority to Canadian Patent Application No. 2,989,566 filed on Dec. 20, 2017, the contents of which are incorporated herein by reference.

### TECHNICAL FIELD

The following relates to systems for monitoring and analyzing piping networks, including monitoring systems that obtain temperature, displacement, and vibration data from such piping networks.

### BACKGROUND

Many industrial systems include piping or piping networks that carry fluids between locations in a plant or apparatus. Depending on the particular application, these piping networks may be subjected to certain potentially harsh environmental conditions. For instance, piping that carries pressurized fluids such as steam can experience high temperatures, and can be subjected to wear due to impurities carried with the fluid, e.g., within blowdown circuits in a coker unit used in upgrading heavy oil, bitumen, vacuum bottoms or similar heavy hydrocarbons.

Any such harsh conditions can contribute to ongoing maintenance-, ageing-, and downtime-related issues, for which monitoring and prevention mechanisms are often desirable or even required.

### SUMMARY

The collection of temperature, displacement and vibration data using strategically placed sensors in a piping network enables potentially high stress locations to be monitored and subsequent actions and/or modeling applied. For example, multi-phase flow effects found in blowdown circuits and other applications can lead to equipment damage issues that could benefit from advance procedures being implemented. Piping networks with tees, elbows and other such high stress locations are found to be impacted during operation in a manner that inputs and outputs alone provide less than the overall state of the piping network.

In one aspect, there is provided a method of monitoring a piping network, the method comprising: obtaining data comprising temperature, displacement, and vibration measurements from a plurality of sensor assemblies selectively installed at a plurality of locations in the piping network, the piping network being subjected to at least one multi-phase flow effect during its operation; and analyzing the data using at least one model to: predict pipe life, detect an operational or pipe damage event, and/or trigger preventative maintenance.

In another aspect, there is provided a system for monitoring a piping network, comprising: a plurality of sensor assemblies selectively installed at a plurality of locations in the piping network, the plurality of sensor assemblies operable to obtain data comprising temperature, displacement, and vibration measurements, the piping network being subjected to at least one multi-phase flow effect during its operation; data acquisition equipment in communication with the plurality of sensor assemblies to acquire the data obtained by the sensor assemblies; and an analytics module comprising a processor operable to analyze the data using at least one model to: predict pipe life, detect an operational or pipe damage event, and/or to trigger preventative maintenance.

In yet another aspect, there is provided a method of monitoring a piping network, the method comprising: obtaining data comprising temperature, displacement, and vibration measurements from a plurality of sensor assemblies selectively installed at a plurality of locations in the piping network, the piping network being subjected to at least one multi-phase flow effect during its operation; and analyzing the data using at least one model to predict pipe life based on stresses experienced by the piping network.

In yet another aspect, there is provided a system for monitoring a piping network, comprising: a plurality of sensor assemblies selectively installed at a plurality of locations in the piping network, the plurality of sensor assemblies operable to obtain data comprising temperature, displacement, and vibration measurements, the piping network being subjected to at least one multi-phase flow effect during its operation; data acquisition equipment in communication with the plurality of sensor assemblies to acquire the data obtained by the sensor assemblies; and an analytics module comprising a processor operable to perform the above method.

In yet another aspect, there is provided a method of monitoring a piping network, the method comprising: obtaining data comprising temperature, displacement, and vibration measurements from a plurality of sensor assemblies selectively installed at a plurality of locations in the piping network, the piping network being subjected to at least one multi-phase flow effect during its operation; and analyzing the data using at least one model to detect an operational or pipe damage event by detecting that an output or effect is not expected.

In yet another aspect, there is provided a system for monitoring a piping network, comprising: a plurality of sensor assemblies selectively installed at a plurality of locations in the piping network, the plurality of sensor assemblies operable to obtain data comprising temperature, displacement, and vibration measurements, the piping network being subjected to at least one multi-phase flow effect during its operation; data acquisition equipment in communication with the plurality of sensor assemblies to acquire the data obtained by the sensor assemblies; and an analytics module comprising a processor operable to perform the above method

In yet another aspect, there is provided a method of monitoring a piping network, the method comprising: obtaining data comprising temperature, displacement, and vibration measurements from a plurality of sensor assemblies selectively installed at a plurality of locations in the piping network, the piping network being subjected to at least one multi-phase flow effect during its operation; and analyzing the data using at least one model to trigger preventative maintenance based on expected events or stresses to the piping network.

In yet another aspect, there is provided a system for monitoring a piping network, comprising: a plurality of sensor assemblies selectively installed at a plurality of locations in the piping network, the plurality of sensor assemblies operable to obtain data comprising temperature, displacement, and vibration measurements, the piping network being subjected to at least one multi-phase flow effect during its operation; data acquisition equipment in communication with the plurality of sensor assemblies to acquire the data obtained by the sensor assemblies; and an analytics module comprising a processor operable to perform the above method.

Advantages of the systems and methods described herein can include the collection and storage of data from a piping network for use in subsequent data analytics and determining when to initiate preventative action. Moreover, model validation of a particular piping network can also be performed, in order to validate a design for, demonstrate the operability of, or detect events in the piping network. A central data center also enables multiple piping networks to be monitored and a larger data set created, to more generally model and generate predictions or alerts, as well as contribute to the design of future piping networks.

### BRIEF DESCRIPTION OF THE DRAWINGS

Embodiments will now be described with reference to the appended drawings wherein:

FIG. 1 is a schematic diagram of a monitoring system for a piping network;

FIG. 2 is a schematic diagram of a temperature measurement setup;

FIG. 3 is a schematic diagram of a displacement measurement setup;

FIGS. 4A and 4B illustrate an example of a configuration for mounting perpendicular displacement sensors;

FIGS. 5A and 5B illustrate an example of a configuration for mounting an axial displacement sensor

FIG. 6 is a temperature sensor layout for a piping network;

FIG. 7A is a temperature sensor profile in a first configuration;

FIG. 7B is a temperature sensor profile in a second configuration;

FIG. 8 is a displacement sensor layout for the piping network shown in FIG. 4;

FIG. 9 is a base station layout for the piping network shown in FIGS. 4 and 6; and

FIG. 10 is a flow chart illustrating computer executable operations performed in collecting and monitoring data acquired for a piping network.

### DETAILED DESCRIPTION

The collection and storage of data acquired from a piping network, for use in subsequent data analytics and preventative action, can be achieved by deploying temperature, displacement, and vibration sensors at strategic locations in a piping network. The following system is particularly suitable for lines that experience temperature fluctuations, vibrations and other displacements, and multi-phase flow effects that can contribute to pipe life issues such as piping stress and reduced life. It has been found that blowdown circuits have historically experienced failures resulting from thermal bowing and liquid slug events. The system and methods described herein enable monitoring, modeling, and predictions to be conducted to improve the reliability and operability of those systems.

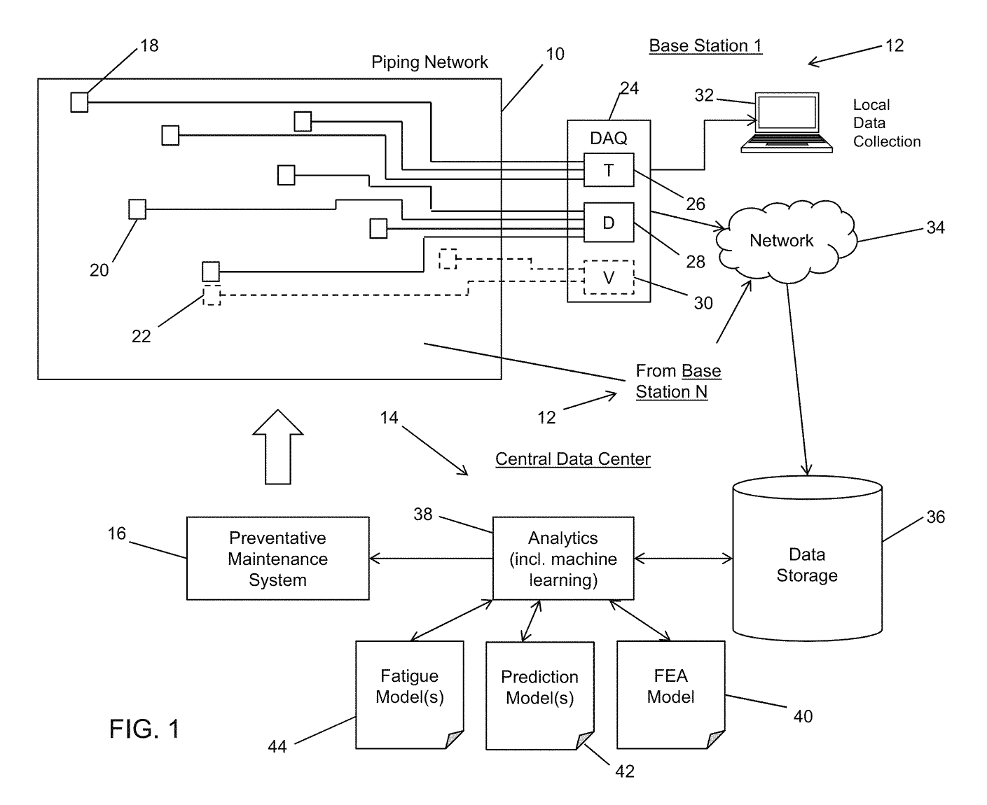

Turning now to the figures, FIG. 1 illustrates an implementation of a system configured for monitoring operating parameters for a piping network 10, for example a blowdown circuit used in a coker unit, or other piping network 10 that experiences multi-phase flow effects. For example, the blowdown circuit in a coker unit can experience temperature fluctuations between ambient temperatures and up to 700 degrees Fahrenheit (F.) and pressures of 40 pounds per square inch (psi). In this example, the piping network 10 is monitored using multiple base stations 12 (base station 1, base station 2, . . . base station N) to acquire data that is transmitted to a central data center 14. The central data center 14 can be used to analyze the acquired data for various purposes such as to identify or predict events, estimate pipe life, and/or to plan advance or preventative maintenance, e.g., by feeding data analytics results to a preventative maintenance system 16.

An analytics module 38 can be used to apply machine learning and/or deep learning using neural networks, to train failure- or event- prediction algorithms and/or to refine existing models such as prediction models 42 and fatigue models 44 that may not capture all events in the piping network 10. For example, a specific prediction model 42 can be developed to enable a continuous analysis and allow for timely prediction of fatigue failure and/or line integrity issues, and subsequent inspection and maintenance planning. Any such machine learning can be used to continually improve the models as more training data is gathered. This also allows additional sensors 18, 20, 22 to be added, removed, or moved as the models demonstrate justification, desire, or a need to do so. By placing the central data center 14 in a remote location, data collection and ongoing monitoring can be implemented without requiring a human presence at the piping network's location.

The piping network 10 is provided with various sensing devices. In this example, temperature sensors 18, displacement sensors 20 and, optionally, vibration sensors 22 are placed throughout the piping network 10 and connected to a data acquisition (DAQ) device 24 in a particular one of the base stations 12 (with connections to base station 1 shown in FIG. 1). The DAQ device 24 can include a chassis or other architecture to accommodate multiple modules/cards for the particular measurements being made at the particular base station 12. In this example, the DAQ device 24 includes a temperature (T) module 26, a displacement (D) module 28, and optionally a vibration (V) module 30. As discussed in greater detail below, in one implementation the displacement sensors 20 can also be used to gather vibration measurements and, in another implementation, separate stand-alone vibration sensors 22 are used to perform vibration monitoring. It can be appreciated that different base stations 12 can performing vibration monitoring in different configurations. For example, one base station 12 can obtain vibration data from displacement sensors 20 while another base station 12 can incorporate additional vibration sensors 22. Similarly, a base station 12 can obtain vibration data from both displacement sensors 20 and vibration sensors 22, with the vibration sensors 22 being placed at additional strategic locations, such as at a midpoint on a relatively long run of piping.

Stand-alone vibration sensors 22 can be provided using any sensor device or package that has a capability of detecting movement. For example, the vibration sensor 22 can be or include an accelerometer, gyroscope, magnetometer, etc. For such devices, both high and low frequency sensors 22 can be used to detect different behaviours depending on the application. The vibration sensors 22 can be mounted using magnetic bases, bolt-on attachment, glue, cement, epoxy, or any other suitable attachment device or compound.

The data gathered by the DAQ device 24 can be provided to a local data collection computer 32 and/or sent to a remote data storage device 36 via a network 34. The network 34 can include a wired network, cellular or other wireless network, or a combination of both wired and wireless networks. It can be appreciated that the data can also be sent over the network 34 via the local data collection computer 32 if a separate Ethernet switch and router (not shown) is not provided. As illustrated in FIG. 1, each base station 12 can provide data to the remote data storage device 36. The remote storage device 36 can include or be embodied as a database, memory, or both. The location of the storage device 36 is central to the base stations 12 to allow for data to be continuously obtained from multiple locations throughout the piping network 10 to minimize or otherwise optimize the cabling and connections required to reach the desired data collection points. Moreover, a centrally located data storage device 36 allows for specifically trained personnel to utilize the data without having to be located at or near the piping network 10 or to visit the facility. The data storage device 36 also allows for data to be backed up, shared, and analyzed and more generally modeled across types or configurations of piping networks 10 in the same or different applications. This allows additional insight in to general issues that can arise that is application agnostic, e.g., line bowing as a result of two-phase flow effects in multiple different deployment configurations.

The central data center 14 can include the analytics module 38, which includes or otherwise has access to the data stored in the data storage device 36. As indicated above, the analytics module 38 can be used to predict or identify events by referencing one or more prediction models 42, to estimate pipe life by referencing one or more fatigue models 44, and provide particular data and information to the preventative maintenance system 16. The analytics module 38 can also be used to validate the performance of the piping network 10 in comparison to a finite element analysis (FEA) model 40. This can be done, for example, to demonstrate that the piping network 10 (or its design) is “fit for service”, e.g., for procedural or regulatory approvals, inspections, etc. In this way, the FEA model 40 can be validated, refined, or challenged on the basis of real data collected within the environment experienced by the piping in the piping network 10. The data stored in the data storage device 36 can also be analyzed by the analytics module 38 to determine if inputs to a particular system appear to be different than before. For example, changes in behaviour experienced by the piping network 10 as reflected in the acquired data can be used to determine that outputs or other effects do not match what is expected, in order to predict that one or more of the inputs are incorrect. For instance, a valve that is left open may affect the amount of fluid entering the piping network 10, which in turn causes a behaviour that can be detected from the acquired data.

As indicated above, in environments such as a blowdown circuit with large temperature fluctuations and multi-phase flow effects (e.g., slug events) monitoring and evaluating only inputs and outputs can be insufficient to model the stresses and potential failures caused by these environments. By collecting temperature, displacement, and vibration measurements throughout the piping network 10 in strategic locations along the line(s) (e.g., at tees, elbows and other high stress locations), a more complete view of what is being experienced throughout the entire piping network 10 can be obtained, modeled, validated, and events related thereto detected and/or predicted.

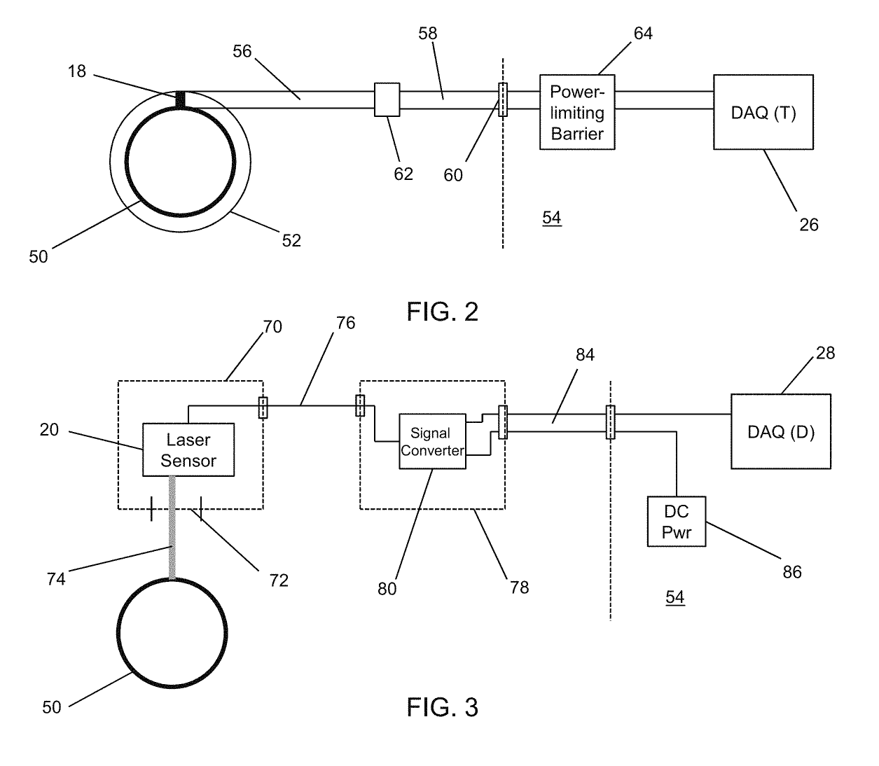

FIG. 2 schematically illustrates a measurement setup for a thermocouple-type temperature sensor 18. In this example the temperature sensor 18 is secured to the exterior surface of a section of pipe 50 using a steel strap 52 or other suitable mounting device. To provide a thermal connection between the pipe 50 and the sensor 18, a high temperature cement can be applied once the sensor 18 and strap 52 are in place. It can be appreciated that the thermal connection can also be achieved using magnetic clamps, mechanical clamps, epoxy, welded studs, etc. For example, the sensor 18 can be a “bolt on” type sensor that includes an eyelet through which a bolt can fit to hold the senor 18 in place. In the example shown in FIG. 2, the temperature sensor 18 is operationally connected or “wired” to a base station enclosure 54 via wiring 56 and an extension wire 58 connected via a connector 62. The connection extends through the enclosure wall via a cable gland 60. It can be appreciated that the extension wire 58 is shown for illustrative purposes wherein additional connection length is required to reach the base station 12, and therefore may not be required depending on the physical location of the sensor 18. Inside the base station enclosure 54 is a power limiting barrier 64 interposed between the sensors 18 and the corresponding DAQ module (T) 26 in the DAQ device 24 to limit power provided to the temperature sensors 18 if a surge occurs. While FIG. 2 illustrates a single temperature sensor 18 connected to the DAQ module 26, it can be appreciated that multiple temperature sensors 18 can be accommodated using the same temperature (T) module 26 installed in the DAQ device 24.

A schematic illustration of a laser-based displacement measurement setup is shown in FIG. 3. In this example a laser sensor assembly 70 containing one or more laser sensors 20 is supported above a section of pipe 50. The laser sensor assembly 70 includes a window or opening, preferably a transparent window 72 to avoid exposing the assembly 70 to potential contaminants in the surrounding environment. The window 72 permits a beam of energy 74 to be directed by the laser sensor 20 towards the pipe 50 to perform a displacement measurement based on an interaction between the beam and the pipe 50. For example, the return time for a reflected beam, the angle of the reflected beam relative to the source beam, changes in the width of the laser beam, energy intensity, or various other behaviours associated with the laser beam 74 can be detected in order to determine how the pipe 50 is being displaced during operation of the piping network 10. It can be appreciated that the laser sensor 20 is shown for illustrative purposes and other sensor packages could be used to perform displacement monitoring, e.g., sonar, ultrasound, video, strain gauges, etc.

The assembly 70 is connected by a first cable 76 to an enclosure 78 that houses a signal converter 80 to convert the laser's signal into an analog signal. The converted signal is provided to the base station enclosure 54 via a second cable 84, e.g., non-incendive cabling. As explained above, cable glands 60 can be used to pass cabling into and out of the enclosures 70, 78, 54. It can be appreciated that the enclosures 70, 78, 54 can be explosion proof for safety and protection purposes. The second cable 84 connects to a DC power source 86 and the DAQ module (D) 28 in the DAQ device 24 that is housed in the enclosure 54. As with FIG. 2, while FIG. 3 illustrates a single laser sensor assembly 70 connected to the DAQ module 28, it can be appreciated that multiple laser sensor assemblies 70 can be accommodated using the same displacement (D) module 28 installed in the DAQ device 24. Moreover, with the configurations shown in FIGS. 2 and 3, selecting equipment with suitable sensitivity, can allow for the capture of substantially instantaneous changes in temperature and displacement within the piping network 10.

For displacement measurements, up to three degrees of freedom (DOFs) can be measured with respect to displacement of the pipe 50 using the laser sensors 20. To measure one DOF, namely in the vertical direction, a laser sensor 20 can be mounted above the pipe 50 with a leveled target placed on top of the pipe 50. In this arrangement it should be assumed that the pipe 50 does not undergo significant rotation during operation. To measure two DOFs, namely two non-axial translational DOFs, a pair of laser sensors 20 can be mounted at ninety (90) degrees from each other (i.e., orthogonally) and aligned perpendicular to the pipes' surface. In this arrangement, it should be assumed that the pipe 50 does not undergo significant rotation and that the pipe's cross-section is and remains circular. To measure three DOFs, three laser sensors 20 can be used. For these measurements, two perpendicularly oriented laser sensor assemblies 70 are directed towards the pipe 50 similar to the two DOF arrangement, with a third laser sensor assembly 70 facing axially along the length of the pipe 50 to a target fixed to the pipe 50.

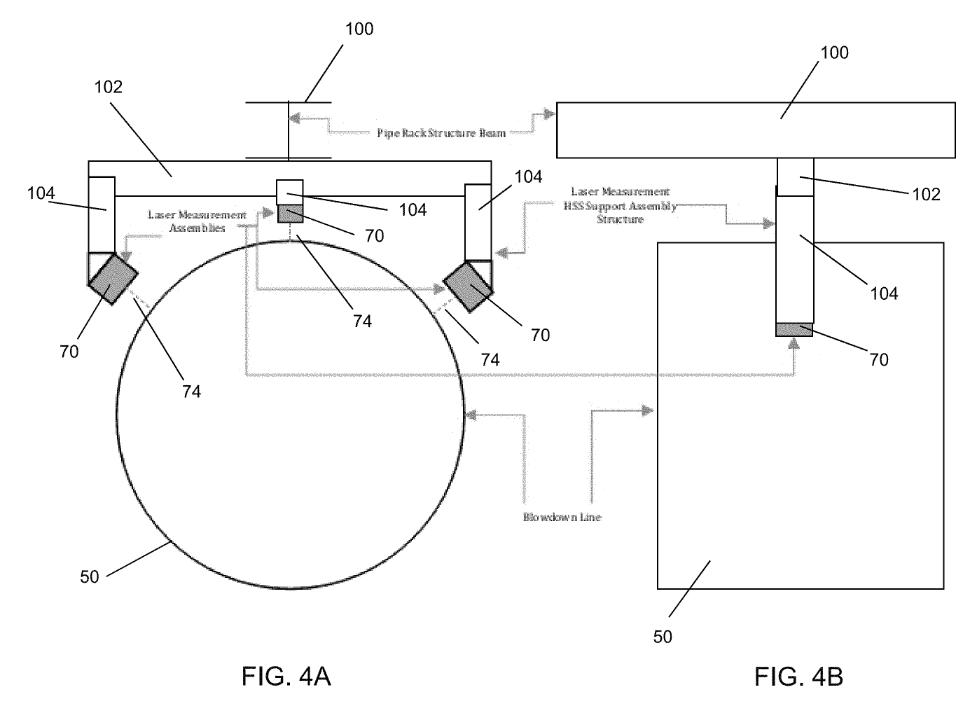

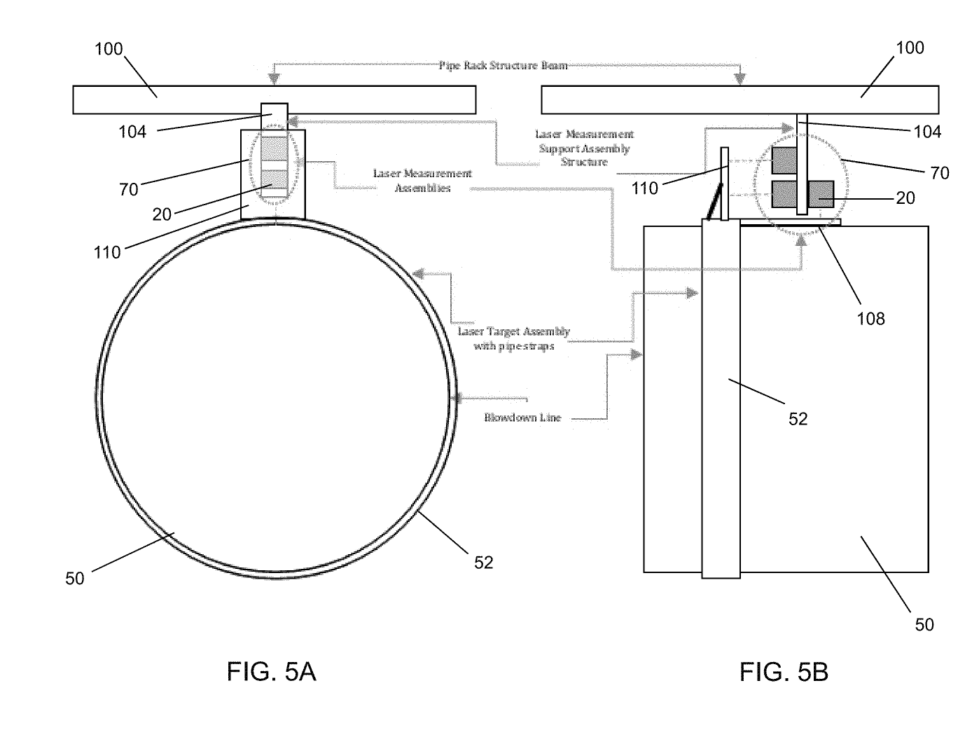

It can be appreciated that unless already present, support frames are built on and/or around the pipe 50 to create fixed reference points. FIGS. 4A, 4B, 5A, and 5B illustrate example structural frames for such a displacement measuring apparatus. As shown in FIG. 4A, the pipe 50 is typically supported by a pipe rack structure. In this example, a beam 100 is located above the pipe 50 and provides an attachment point for a cross-member 102. Extending downwardly from the cross-member 102 are sensor mount supports 104 for the laser sensor assemblies 70. FIG. 4A illustrates the perpendicularly oriented sensor assemblies 70 on each side of the pipe 50 for directing energy (i.e. a laser beam 74) generated by the laser sensors 20 perpendicularly towards the outer surface of the pipe 50. FIG. 4B illustrates the positioning of the mount supports 104 from a side view.

FIGS. 5A and 5B provide further detail of the centrally located laser sensor assembly 70. As best seen in FIG. 5B, the central laser sensor assembly 70 can include both the vertically directed sensor assembly 20 (shown mounted at the rear of the support 104 in FIG. 5B), and transmitting and receiving laser sensors 20 (shown mounted at the front of the support 104 in FIG. 5B). The vertically directed sensor assembly 20 is directed at a horizontally oriented target 108 supported in a level position atop the pipe 50. The transmitting and receiving laser sensors 20 are directed axially towards a vertically oriented target 110 that is mounted atop the pipe 50 using a strap 52 or other support structure/member.

With the sensor assemblies 70 mounted as illustrated in FIGS. 4 and 5, displacement measurements with three DOFs can be gathered.

It can be appreciated that stand-alone vibration sensors 22 can be positioned at a particular section of pipe 50 and wired to the DAQ device 24 in a similar manner, which accommodates and accounts for any hardware elements required to send, convert, and otherwise process the data acquired by the sensor 22. This can be done to ensure the data is in a format that is understandable to the DAQ device 24.

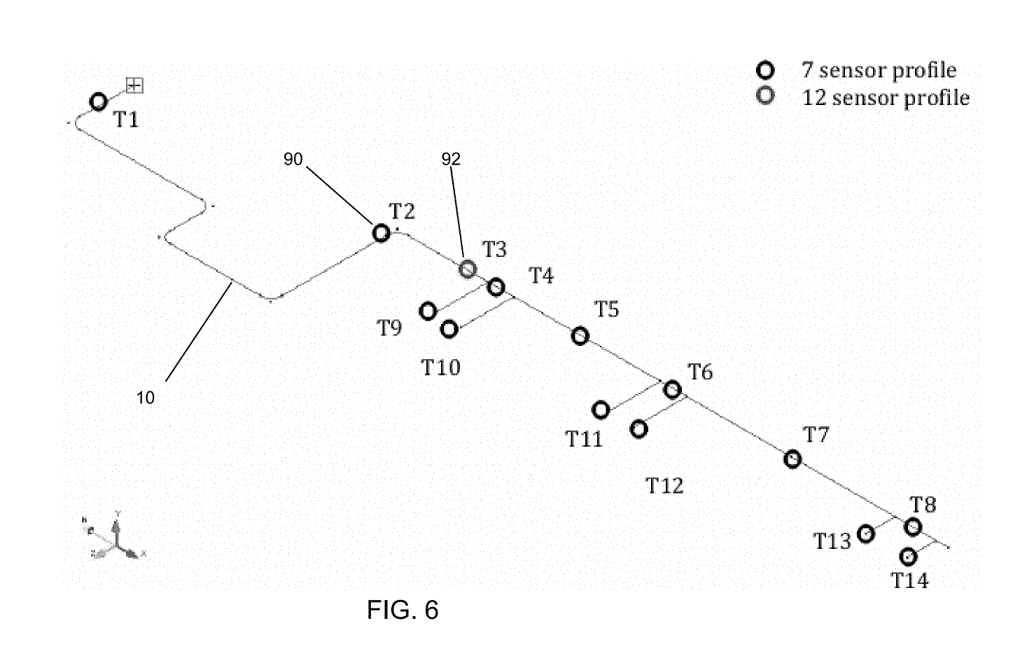

FIG. 6 illustrates a temperature sensor layout for a piping network 10. In this illustrative example, temperature sensors 18 are placed at fourteen locations, with thirteen of fourteen sensor assemblies having a first sensor profile 90 and the other assembly having a second sensor profile 92.

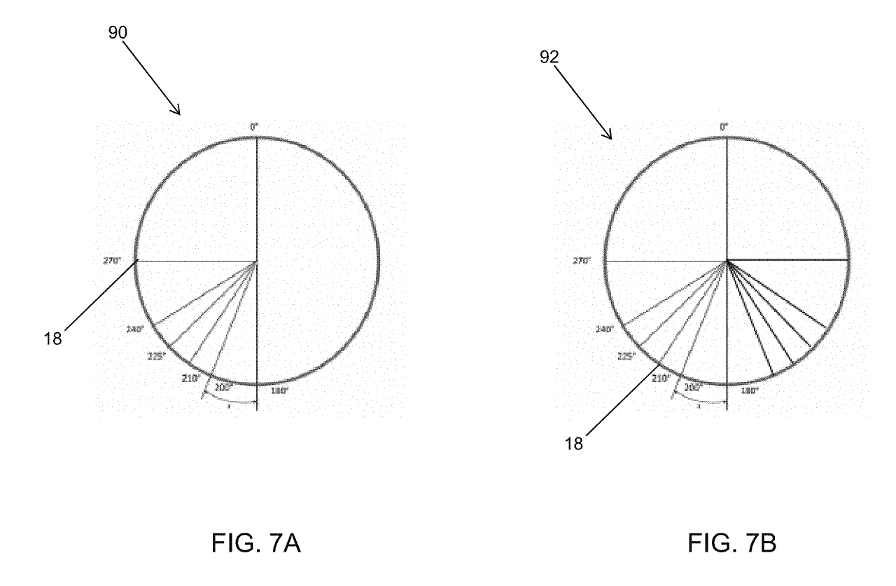

For example, the first sensor profile 90 can include seven sensors arranged as shown in FIG. 7A, and the second sensor profile 92 can include twelve sensors arranged as shown in FIG. 7B. In the configuration shown in FIG. 6, one hundred and three thermocouples or other temperature sensors 18 would be required to conduct the temperature monitoring for the piping network 10 according to the layout shown.

It can be appreciated that the number of and location for the temperature sensors 18 can vary based on varying expectations as to whether or not such areas would be high stress locations. The number of and position for such temperature sensors 18 can also be changed over time based on the data acquisition readings and as the piping network 10 or its operations change. It can be appreciated that the sensor profiles 90, 92 shown in FIG. 7 are examples that illustrate how the number and positioning of these devices 18 can be varied to suit different applications. For example, where a liquid level is expected, the locations for the sensors 18 can be optimized to target the bottom portion of the pipe 50 that would be more likely to experience effects caused by such a liquid level. Moreover, these examples demonstrate suitable “coverage” of the pipe 50 while considering cost. Without cost constraints, for example, additional temperature sensors 18 can be spaced about the entirety of the pipe 50 and the exact number of sensors 18 and the spacing between the sensors 18 can be varied for the particular application and/or the particular targeted location within that application. It can also be appreciated that the number of sensors 18 can be affected by the diameter of the pipe 50, with a larger diameter pipe 50 requiring additional sensors 18 for the same coverage as a relatively smaller pipe 50. Moreover, the DAQ device 24 and number of T modules 26 can be affected by having greater or fewer temperature sensors 18. Similarly, the greater the number of sensors 18, the greater the amount of data that is collected, stored, transmitted, and processed.

As shown in FIGS. 7A and 7B, the second sensor profile 92 includes five additional temperature sensors 18 circumferentially spaced such that sensors 18 are positioned on both sides of the vertical centerline to provide additional information about the temperature gradient along the cross-section of the pipe 50. The arrangement of the temperature sensors 18 can allow the fluid level in, and thermal bowing of the pipe 50 to be determined in a way that the sensor layout is optimized for the particular application and piping network 10.

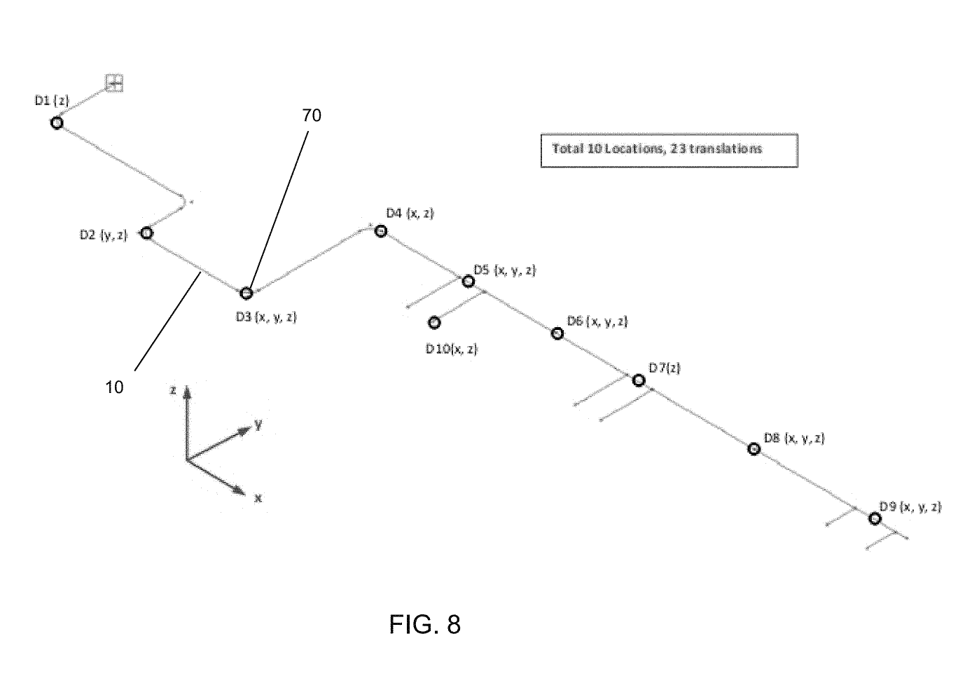

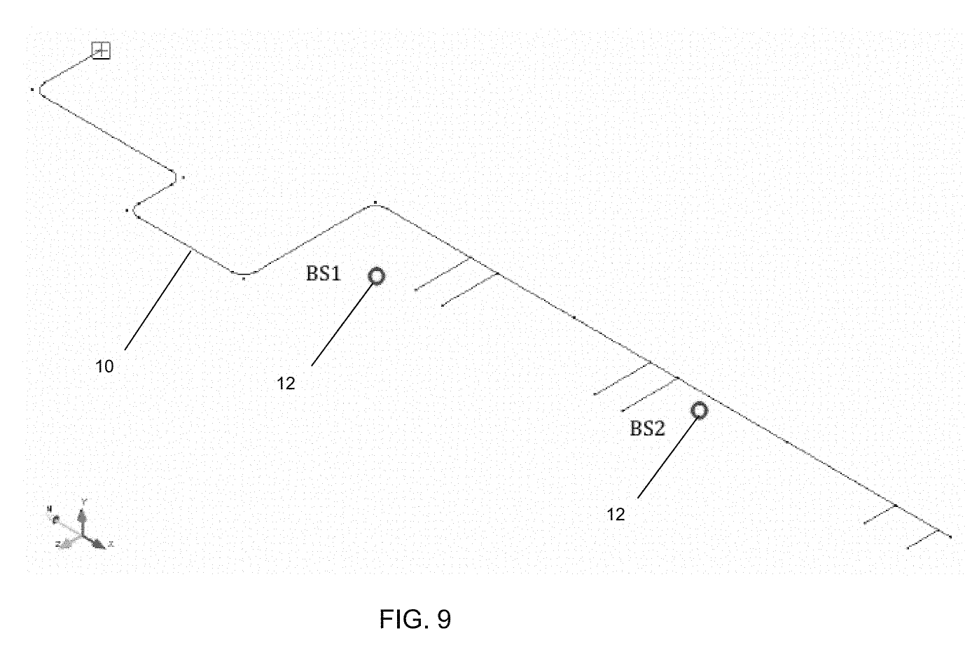

FIG. 8 illustrates a displacement sensor layout for the piping network 10. Each location (i.e., D1, D2, etc.) shown in FIG. 9 includes an indication of one, two or three coordinates to provide an example of a configuration for gathering particular displacement data at those locations. For example, D1(z) includes a configuration for measuring vertical displacement using a vertically oriented laser sensor 20 as shown in FIG. 4A. D3(x, y, z) on the other hand includes a configuration that measures translation in three DOFs, as shown in both FIGS. 4 and 5. It can be appreciated that the sensitivity of the laser sensors 20 allow permits vibrations measurements to be made using the displacement sensor layout, at the locations indicated. In this way, both line movement and vibrations caused by the different cycles experienced during operation of the piping network 10 can be analyzed. Moreover, the displacement sensor layout can be designed to detect slug and other “upset” events by analyzing trends associated with the displacement and vibration measurements. In the example shown in FIG. 8, ten locations are used, which collectively measure twenty three translations of sections of the piping network 10.

It can be appreciated that the number of and location for the laser sensors 20 can vary based on the expectation that such areas would be high stress locations or otherwise experience line movement or upset events. The number of and position for such sensors 20 can also be changed over time based on the data acquisition readings and as the piping network 10 or its operation changes. This enables sufficient flexibility to adapt and refine the monitoring system as the environment, equipment, operating conditions and/or other factors change.

To increase the accuracy and reliability of the displacement measurements, the absolute position of at least one of the displacement measurement assemblies 70 can be determined when the sensor layout is first set up. This allows the “zeroing” of a reference point to provide absolute reference coordinates for determining a slope or sag in a line as well as the displacements relative to the absolute reference coordinates. The absolute reference can be chosen using a fixed object or structure, such as a support beam for the assembly 70. By zeroing all displacement measurement assemblies prior to using the monitoring system, numerous relative measurements can be obtained over time. For example, slope measurements between laser sensor assemblies 70 can provide insight into bowing or sagging of a line the extends between the points of measurement.

Any of the translations measured by the displacement sensors 20 can also track information about vibration of the piping network 10, e.g., where an event causes a particular portion of the pipe 50 to move in a particular direction at a measured frequency. For example, the displacement sensors 20 illustrated herein have been found to provide enough sensitivity to vibrations to capture vibrations up to 100 Hz. As indicated above, vibration measurements can be obtained using the displacement sensors 20, separate vibration sensors 22, or both. For example, over time as additional vibration measurements are desired, vibration sensors 22 can be added without necessarily requiring additional displacement sensors 20.

FIG. 9 provides an example of a base station layout for the piping network 10 that positions two base stations 12 at spaced locations to minimize the cabling requirements for the particular sensor assemblies. It can be appreciated that the number of DAQ devices 24 and base stations 12 generally can be dictated by limitations in the number of DAQ inputs and thus the number of sensor assemblies in the piping network 10. The number of base stations 12 can be increased, or the number of DAQ devices 24 located at a particular base station 12 can be increased in order to accommodate various capacity requirements and sensor data traffic.

Data in the piping network 10 can be collected and managed using any suitable data collection scheme. For example, when using thermocouples for the temperature sensors 18, data can be collected at a sample rate of 1 sample/second, and one data point saved per 30 second period. However, faster sampling rates may be desired in some applications or with certain sensors 18 located in targeted areas. As such, the example data collection metrics exemplified here are for illustrative purposes only. When a temperature change is detected during that sampling period, additional data points can be saved and more frequent data points saved thereafter until the temperature change drops to below a threshold. In other words, data collection and data storage techniques can be used to manage the potentially large amounts of data that would accumulate over time, such that important data points are captured periodically or during temperature rise/fall events. Displacement data can also be collected at a particular sampling rate, e.g., 40 samples/second. Similar to the temperature sensors 18 faster or slower sampling rates may be desired in certain applications or at certain locations.

As indicated above, the data that is collected by the sensors deployed in the piping network 10 are fed to the base stations 12 and received by a local data collection computer 32 and/or router (not shown in figures). This allows data to be saved locally using the computer 32 and periodically transmitted (e.g., hourly) to the central data center 14 over a network 34 for primary data collection and storage from all base stations 12 in the data storage device 36. In this way, the entire piping network 10 can be modeled and analyzed over time in a centralized manner. Moreover, multiple piping networks 10, each potentially having multiple base stations 12 can feed data to the central data storage device 36 to perform larger studies across multiple plants/apparatus/locations/applications, etc.

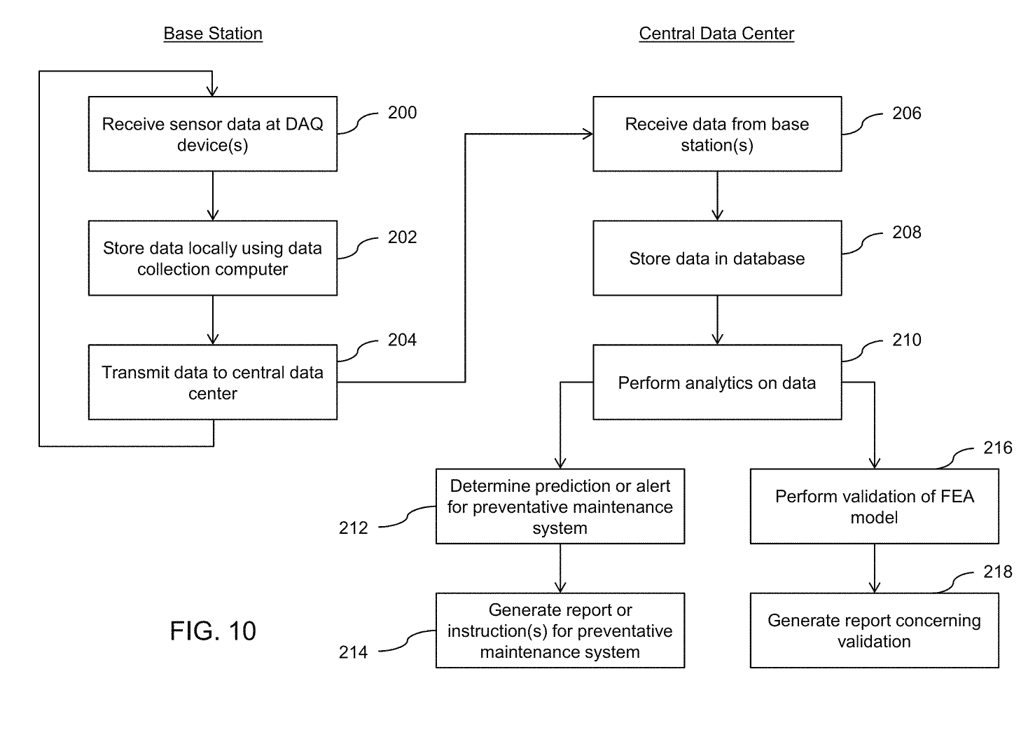

FIG. 10 is a flow chart illustrating computer executable instructions for gathering, transmitted, storing, and analyzing sensor data in a piping network 10. At step 200, the base station's DAQ device(s) 24 receive sensor data collected by the various temperature sensors 18, displacement sensors 20 and vibration sensors 22. The received data is stored locally using the data collection computer 32 at step 202, and then transmitted periodically to the central data center 14 at step 204. The central data center 14 receives the data that has been transmitted from the base station 12 at step 206 and stores the data in a database on the data storage device 36 at step 208. The database can organize data on a per-piping network 10 and per-base station 12 basis to enable different locations and sensor layout configurations to be modeled and compared over time. Data can also be organized on a per-sensor or per-sensor type basis for similar purposes. By centrally storing the data as shown in FIG. 1, advanced data analytics and machine learning can be applied at step 210, e.g., to continuously improve the maintenance and future designs or modifications of piping networks 10 in particular applications, locations, and configurations. The data analytics can also be performed against fatigue models 44 and prediction models 42 in order to detect or preempt certain events. For fatigue models 44, certain events or issues identified in the data, such as certain pipe wear or integrity issues can be used to reduce the pipe life in the fatigue model 44 accordingly.

Two examples are shown in FIG. 10. At step 212, a prediction or alert with respect to an operational piping network 10 is determined from the analytics applied to the data, such that a report, instruction, or set of instructions can be generated for the preventative maintenance system 16 at step 214. In the other example shown in FIG. 10, analytics are applied to perform a validation of an FEA model of the piping network 10 at step 216, such that a reporting concerning the validation is generated at step 218. Such a report enables a model validation to be used for obtaining approvals or to satisfy monitoring or analysis requirements that may be imposed upon the operation of the piping network 10, e.g., to demonstrate that the piping network 10 is “fit for service”.

Various data reports can be generated periodically, for instance on a weekly basis. Such data reports can include observations based on the data collected during that period, or specific temperature, displacement and/or vibration-specific reports. Some example temperature reports include:
temperature vs. time, over the preceding period of time, for all locations with 1 plot per cross-section, or
temperature vs. time, with close-ups for interesting events that have been detected.

Some example displacement reports include:
displacement vs. time, over the entire period, for all locations, with 1 DOF per plot,
X displacement vs. Y displacement, for interesting events,
X displacement vs. Z displacement, for interesting events,
Z displacement vs. Y displacement, for interesting events, or
ME Scope Animation of displacement over that period.

Some example vibration reports include:
average and peak amplitude vs. time, over the entire period, for all locations, with 1 direction per plot
velocity and displacements spectra for interesting events, or
ME Scope Animation of interesting events.

The ME Scope Animation refers to the ability to stitch together a video or animation of the piping network 10 or a portion thereof, to illustrate how the piping network 10 is affected by certain events and to show how this changes over time, in a controlled and analytical manner. For example, stress inducing or failure events can be animated in slow motion to track and detect particular issues. This can lead to the deployment of additional sensors 18, 20, 22 for further analyses, or an intervention, routine maintenance or other remedial action.

It can be appreciated that any suitable analytics can be applied to the data that is stored to improve operations, prevent or minimize maintenance disruptions, design future piping networks 10 in similar applications, etc. and the examples shown herein are illustrative. In particular, the system shown in FIG. 1 can be applied in various applications where temperature, displacement and vibration effects are experienced by the piping network 10 or portions thereof, such as two-phase flow effects that create specific wear and tear on the piping 50.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the base station 12 or central data center 14, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of monitoring a piping network, the method comprising:
obtaining data comprising temperature, displacement, and vibration measurements from a plurality of sensor assemblies selectively installed at a plurality of locations in the piping network, the piping network being subjected to at least one multi-phase flow effect during its operation; and
analyzing the data using at least one model to: predict pipe life, detect an operational or pipe damage event, and/or trigger preventative maintenance.

2. The method of claim 1, wherein the at least one multi-phase flow effect comprises a high temperature fluctuation.

3. The method of claim 1, wherein the at least one multi-phase flow effect comprises fluid slug events.

4. The method of claim 1, wherein the at least one model comprises a model that is generated using at least one machine learning algorithm and training data corresponding to the data measurements gathered over a period of time.

5. The method of claim 1, wherein the at least one model comprises an existing model for the piping network characterizing fatigue failure in the piping network, and further comprising updating the existing model over time to reduce pipe life according to one or more detected events.

6. The method of claim 1, further comprising generating a report or instruction for a preventative maintenance system based on the analyzing of the data using the at least one model.

7. The method of claim 1, further comprising comparing the analyzed data to a finite element analysis (FEA) model to validate the FEA model.

8. The method of claim 1, wherein the data is received from the plurality of sensor assemblies by at least one data acquisition (DAQ) device located at a base station at or near the piping network, the at least one DAQ device sending the data to a data storage device at a central data center for performing the analyzing.

9. The method of claim 8, wherein the data is stored at a local data collection computer and sent to the data storage device over a network.

10. The method of claim 8, wherein the data is received by at least one DAQ device located at a respective one of a plurality of base stations at or near the piping network, each base station being connected to at least one sensor assembly.

11. The method of claim 1, wherein the temperature measurements are obtained by at least one temperature sensor in contact with a section of pipe in the piping network.

12. The method of claim 11, wherein the temperature sensor comprises at least one thermocouple.

13. The method of claim 11, comprising a temperature sensing assembly having a plurality of circumferentially spaced temperature sensors in contact with the section of pipe to enable temperature gradient measurements along at least a portion of a cross section of the section of pipe.

14. The method of claim 13, comprising a first type of temperature sensing assembly having a first number of temperature sensors, and a second type of temperature sensing assembly having a second number of temperature sensors.

15. The method of claim 1, wherein the displacement measurements are obtained by at least one displacement sensor assembly supported relative to a section of pipe in the piping network.

16. The method of claim 15, wherein the at least one displacement sensor assembly comprises a vertically oriented laser sensor directed towards an outer surface of the pipe to detect one degree of freedom (DOF).

17. The method of claim 15, wherein the at least one displacement sensor assembly comprises a pair of orthogonal laser sensors each directed at a right angle to the outer surface of the pipe to detect a second DOF.

18. The method of claim 15, wherein the at least one displacement sensor assembly comprises at least one laser sensor axially aligned with the section of pipe and directed towards a target supported by the section of pipe to determine axial displacement for a third DOF.

19. A system for monitoring a piping network, comprising:
a plurality of sensor assemblies selectively installed at a plurality of locations in the piping network, the plurality of sensor assemblies operable to obtain data comprising temperature, displacement, and vibration measurements, the piping network being subjected to at least one multi-phase flow effect during its operation;
data acquisition equipment in communication with the plurality of sensor assemblies to acquire the data obtained by the sensor assemblies; and
an analytics module comprising a processor operable to analyze the data using at least one model to: predict pipe life, detect an operational or pipe damage event, and/or to trigger preventative maintenance.

20. The system of claim 19, further comprising a local computing device connected to the data acquisition equipment for locally storing data and sending the acquired data to a central data center comprising the analytics module.

21. The system of claim 19, wherein the at least one multi-phase flow effect comprises a high temperature fluctuation.

22. The system of claim 19, wherein the at least one multi-phase flow effect comprises fluid slug events.

23. The system of claim 19, wherein the at least one model comprises a model that is generated using at least one machine learning algorithm and training data corresponding to the data measurements gathered over a period of time.

24. The system of claim 19, wherein the at least one model comprises an existing model for the piping network characterizing fatigue failure in the piping network, and further comprising updating the existing model over time to reduce pipe life according to one or more detected events.

25. The system of claim 19, further comprising generating a report or instruction for a preventative maintenance system based on the analyzing of the data using the at least one model.

26. The system of claim 19, further comprising comparing the analyzed data to a finite element analysis (FEA) model to validate the FEA model.

27. The system of claim 19, wherein the data is received from the plurality of sensor assemblies by at least one data acquisition (DAQ) device located at a base station at or near the piping network, the at least one DAQ device sending the data to a data storage device at a central data center for performing the analyzing.

28. The system of claim 27, wherein the data is stored at a local data collection computer and sent to the data storage device over a network.

29. The system of claim 27, wherein the data is received by at least one DAQ device located at a respective one of a plurality of base stations at or near the piping network, each base station being connected to at least one sensor assembly.

30. The system of claim 19, wherein the temperature measurements are obtained by at least one temperature sensor in contact with a section of pipe in the piping network.

31. The system of claim 30, wherein the temperature sensor comprises at least one thermocouple.

32. The system of claim 30, comprising a temperature sensing assembly having a plurality of circumferentially spaced temperature sensors in contact with the section of pipe to enable temperature gradient measurements along at least a portion of a cross section of the section of pipe.

33. The system of claim 32, comprising a first type of temperature sensing assembly having a first number of temperature sensors, and a second type of temperature sensing assembly having a second number of temperature sensors.

34. The system of claim 19, wherein the displacement measurements are obtained by at least one displacement sensor assembly supported relative to a section of pipe in the piping network.

35. The system of claim 34, wherein the at least one displacement sensor assembly comprises a vertically oriented laser sensor directed towards an outer surface of the pipe to detect one degree of freedom (DOF).

36. The system of claim 34, wherein the at least one displacement sensor assembly comprises a pair of orthogonal laser sensors each directed at a right angle to the outer surface of the pipe to detect a second DOF.

37. The system of claim 34, wherein the at least one displacement sensor assembly comprises at least one laser sensor axially aligned with the section of pipe and directed towards a target supported by the section of pipe to determine axial displacement for a third DOF.
